(19) United States
(12) Patent Application Publication
(10) Pub. No.: US 2025/0203503 A1
(43) Pub. Date: Jun. 19, 2025

(54) TROPOSPHERIC DUCTING INTERFERENCE MITIGATION THROUGH IDLE MODE RE-SELECTION

(71) Applicant: T-Mobile Innovations LLC, Overland Park, KS (US)

(72) Inventor: Jasinder Pal Singh, Olathe, KS (US)

(21) Appl. No.: 18/543,517

(22) Filed: Dec. 18, 2023

(51) Int. Cl. H04W 48/20; H04B 17/336; H04L 5/14; H04W 56/00

(52) U.S. Cl. CPC H04W 48/20; H04B 17/336; H04L 5/1469; H04W 56/0015

(57) ABSTRACT

Methods for mitigating the effects of an atmospheric-based interference event on the propagation of a radio frequency (RF) signal are provided. A wireless communication network may determine that tropospheric ducting is occurring, causing radio frequencies to travel much further than anticipated. In response to the determination of tropospheric ducting interference (TDI), the idle mode cell re-selection priority is adjusted to give frequency domain duplexing (FDD) priority for affected cells. When TDI is reduced, the idle mode cell re-selection priority is switched back to time domain duplexing (TDD).

### SUMMARY

The present disclosure is directed to mitigating time of flight interference, substantially as shown and/or described in connection with at least one of the Figures, and as set forth more completely in the claims.

According to various aspects of the technology, tropospheric weather conditions can cause radio signals associated with a wireless communication network to travel farther than intended, to a location or area that is undesirable. This time of flight interference causes degraded user experiences at the distant, victim cell. To mitigate this time of flight interference, the idle mode cell re-selection priorities of multiple user equipment (UE) may be changed from Time Domain Duplexing (TDD) to Frequency Domain Duplexing (FDD), giving FDD bands high priorities for cells affected by time of flight interference. When time of flight interference is reduced, the idle mode cell re-selection default priorities of the UEs are switched back to give TDD bands priority over FDD bands.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Implementations of the present disclosure are described in detail below with reference to the attached drawing figures, wherein:

FIG. 1 illustrates an exemplary computing device for use with the present disclosure;

FIG. 2 depicts a network environment in which implementations of the present disclosure may be employed, in accordance with aspects herein;

FIG. 3 depicts a diagram of tropospheric ducting occurring in a network environment; and

FIG. 4 depicts a flow diagram of an exemplary method for mitigating tropospheric ducting interference in a wireless telecommunication network in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like. The term “node” is used to refer to network access technology for the provision of wireless telecommunication services from a base station to one or more electronic devices, such as an eNodeB, gNodeB, etc. The term “cell” is used to describe one or more hardware and software components of a base station that are configured to provide wireless communication service to a geographic area.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, time of flight interference is a condition wherein radio frequency signals associated with a wireless communication network are realized in a location or area that is undesirably distant from its transmitter. In some instances, signals from a transmitter that are intended to travel 10 miles or less may travel for dozens or hundreds of miles. One cause of time of flight interference is tropospheric ducting. Tropospheric ducting is a meteorological phenomenon whereby layers of warm and cold air form at different altitudes. When a layer of warm air is trapped between two layers of cold air, a duct of warm air is created. Radio frequency signals become trapped in the duct of warm air, causing them to travel a greater distance than they would under normal conditions. This can result in interference and a degraded experience for users. Network operators prefer to keep user equipment connected using a TDD frequency such as the n41 layer because it offers higher bandwidth capacity. However, there is a potential for tropospheric ducting when using TDD. The present disclosure describes changing the idle mode cell re-selection priorities of UEs experiencing time of flight interference from TDD to Frequency Division Duplexing (FDD) (e.g., n71, b2, b66, n25) to mitigate ducting interference and preserve user experiences. When time of flight interference is reduced and tropospheric ducting is no longer occurring, the idle mode cell reselection priorities of UEs may be switched back to give TDD higher priority.

Conventionally, systems and methods capable of addressing radio frequency signal interference resulting from tropospheric ducting include weather forecasting potential tropospheric ducting events and taking measures to optimize network configurations in order to temporarily minimize interference during the events. Specifically, when weather conditions are ideal one or more antennas on a base station may be tilted to avoid intercepting interfering frequencies from a distant base station, or the amount of transmitting power used by an antenna to maintain a stable link may be adjusted. The adjustments that can be made to the network configurations are limited, however. Operators must work within certain limitations of the wireless network. In addition, the nature of tropospheric ducting is unstable. Tropospheric ducting is highly dependent on weather conditions and atmospheric temperature profiles. It can occur unexpectedly and is challenging to predict accurately. This unpredictability can make it difficult to plan and manage wireless communication systems effectively. Even if predicted or detected quickly and accurately, because conventional solutions to mitigating time of flight interference in a cell involve reconfigurations of antenna or signal propagation characteristics, they are slow to implement, imprecise, and may have undesirably inadvertent consequences (e.g., reducing an area served by a cell due to a downtilt).

Unlike conventional solutions, the present disclosure describes detecting increased interference during the uplink subframe of a network using a Time Domain Duplexing method of duplex communication (TDD) and changing the idle mode cell re-selection priorities of user equipment to give Frequency Domain Duplexing (FDD) bands higher priority over TDD bands for affected cells. During tropospheric weather events, interference can be experienced in the uplink traffic of TDD bands, which use the same frequency for uplink and downlink. Interference from tropospheric ducting will specifically occur when TDD switches from downlink to uplink after a guard period. Therefore, when interference occurs at the beginning of the uplink subframe and reduces in the remaining frame, the interference may be attributable to tropospheric ducting. To mitigate this interference, when interference is detected at the beginning of the uplink and reduces in the remaining sub-frame, the idle mode cell re-selection priorities are changed to give FDD bands higher priorities for affected cells-causing a UE to select and camp on to an FDD cell instead of the TDD cell affected by the time of flight interference. The present disclosure also describes changing the idle mode cell re-selection priorities back to TDD over FDD once the tropospheric phenomenon is reduced.

Accordingly, a first aspect of the present disclosure provides a system for mitigating interference caused by a meteorological condition known as tropospheric ducting in a wireless communication network. The system comprises one or more computer processing components configured to perform operations. The operations comprises first determining that time of flight interference is occurring during an uplink subframe of a victim cell, wherein the victim cell uses time domain duplexing to wirelessly communicate with a UE in a geographic area served by the victim cell. The operations next comprises, based on said determination, communicating a first set of modified synchronization signals to the geographic area served by the victim cell, the modified synchronization signals comprising one or more cell selection values that cause the UE to select a second cell over the victim cell.

A second aspect of the present disclosure provides a system for mitigating interference caused by a meteorological condition known as tropospheric ducting in a wireless communication network. The system comprises one or more computer processing components configured to perform operations. The operations comprises first determining that time of flight interference is occurring during an uplink subframe of a victim cell, wherein the victim cell uses time domain duplexing to wirelessly communicate with a UE in a geographic area served by the victim cell. The operations next comprises, based on said determination, communicating a first set of modified synchronization signals to the geographic area served by the victim cell, the modified synchronization signals comprising one or more cell selection values that cause the UE to select a second cell over the victim cell. begins with receiving a measurement of interference at the beginning of an uplink subframe after a guard period from the wireless telecommunication network. The network then measures a corresponding interference throughout the uplink subframe. Then, the network determines a ratio of the interference at the beginning of the uplink subframe to the interference throughout the uplink subframe exceeds a predetermined threshold. The method concludes with adjusting the idle mode cell re-selection priority of a user equipment.

Another aspect of the present disclosure is directed to a non-transitory computer readable media having instructions stored thereon that, when executed by one or more computer processing components, cause the one or more computer processing components to perform a method for mitigating interference caused by a meteorological condition known as tropospheric ducting in a wireless telecommunication network. The method comprises determining that time of flight interference is occurring during an uplink subframe of a victim cell, wherein the victim cell uses time domain duplexing to wirelessly communicate with a UE in a geographic area served by the victim cell. The method further comprises, based on said determination, communicating a first set of modified synchronization signals to the geographic area served by the victim cell, the modified synchronization signals comprising one or more cell selection values that causes the UE to select a second cell over the victim cell.

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

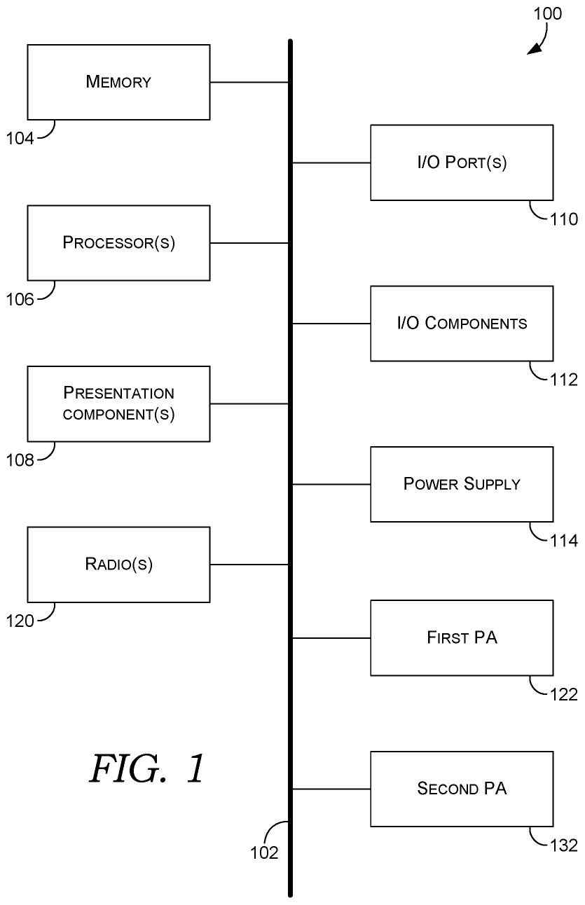

The radio 120 represents one or more radios that facilitate communication with one or more wireless networks using one or more wireless links. While a single radio 120 is shown in FIG. 1, it is expressly contemplated that there may be more than one radio 120 coupled to the bus 102. In aspects, the radio 120 utilizes a transmitted to communicate with a wireless telecommunications network. It is expressly contemplated that a computing device 100 with more than one radio 120 could facilitate communication with the wireless network via both the first transmitter and additional transmitters (e.g., a second transmitter). Illustrative wireless telecommunications technologies include CDMA, GPRS, TDMA, GSM, and the like. The radio 120 may carry wireless communication functions or operations using any number of desirable wireless communication protocols, including 802.11 (Wi-Fi), WiMAX, LTE, 3G, 4G, LTE, 5G, NR, VOLTE, or other VoIP communications. As can be appreciated, in various embodiments, radio 120 can be configured to support multiple technologies and/or multiple radios can be utilized to support multiple technologies. A wireless telecommunications network might include an array of devices, which are not shown as to obscure more relevant aspects of the invention. Components such as a base station or communications tower (as well as other components) can provide wireless connectivity in some embodiments.

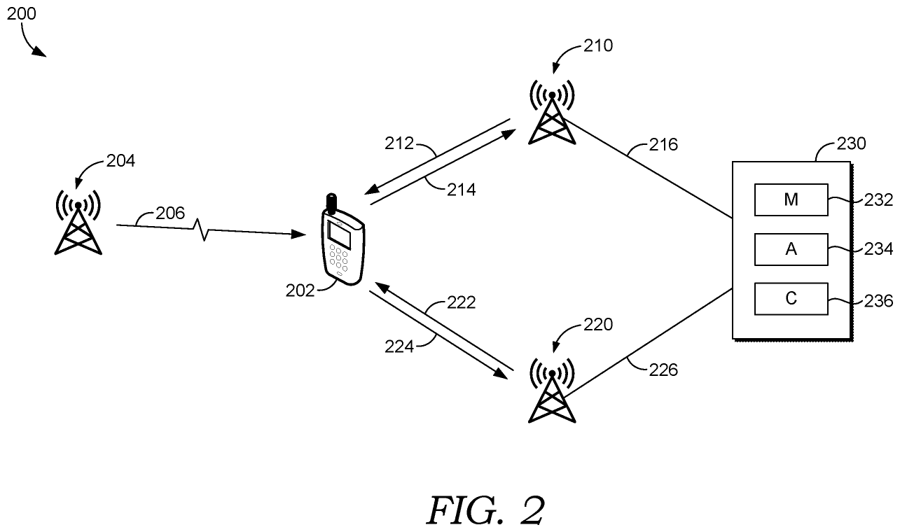

Turning now to FIG. 2, an exemplary network environment is illustrated in which implementations of the present disclosure may be employed. Such a network environment is illustrated and designated generally as network environment 200. At a high level the network environment 200 comprises a UE 202, one or more base stations, and one or more networks. Though the UE 202 is illustrated as a cellular phone, a UE suitable for implementations with the present disclosure may be any computing device having any one or more aspects described with respect to FIG. 1. Similarly, though the one or more base stations are illustrated as macro cells on a cell tower, any scale or form of access point acting as a transceiver station for wirelessly communicating with a UE, including small cells, pico cells, and the like, are suitable for use with the present disclosure. The network environment 200 is but one example of a suitable network environment and is not intended to suggest any limitation as to the scope of use or functionality of the disclosure. Neither should the network environment 200 be interpreted as having any dependency or requirement to any one or combination of components illustrated.

The network environment 200 comprises one or more base stations to which the UE 202 may potentially connect to (also referred to as ‘camping on’, ‘attaching’ in the industry). Though the network environment 200 is illustrated with three distinct base stations, one skilled in the art will appreciate that more or fewer base stations may be present in any particular network environment suitable for use with the present disclosure. The one or more base stations of network environment 200 may comprise one or more of an aggressor base station 204, a victim base station 210, and a target base station 220. Each of the one or more base stations of the network environment 200 is configured to wirelessly communicate with UEs, such as the UE 202. In aspects, any of the one or more base stations may communicate with a UE using any wireless telecommunication protocol desired by a network operator, including but not limited to 3G, 4G, 5G, 6G, 802.11x and the like. Relevant to the present disclosure, each of the one or more base stations is associated with a network identifier (e.g., a Public Land Mobile Network (PLMN) number). Each of the one or more base stations may be generally said to be configured to communicate with one or more UEs located within a geographical area. A geographical area for any particular base station may be referred to as the “coverage area” of the base station or simply as a “cell.” In some aspects, each cell is defined by an area in which signaling between a particular UE and the base station is usable for any purpose. Each of the base stations of the network environment 200 may be used to provide coverage to a plurality of cells, wherein one or more of the plurality of cells at least partially overlap; for example, the victim base station 210 may provide coverage to a first cell and a second cell, wherein the first cell and the second cell at least partially overlap. Generally, each base station of the one or more base stations may comprise one or more base transmitter stations, radios, antennas, antenna arrays, power amplifiers, transmitters/receivers, digital signal processors, control electronics, GPS equipment, and the like.

Each base station of the network environment 200 is configured to transmit downlink signals to one or more UEs, such as the UE 202 and to receive uplink signals therefrom. For the purposes of network environment 200, the victim base station 210 transmits downlink signals on a first downlink 212, the target base station 220 transmits downlink signals on a second downlink 222, the victim base station 210 receives uplink signals on a first uplink 214, the target base station 220 receives uplink signals on a second uplink 224, and the aggressor base station transmits downlink signals on a third downlink 206. Downlink signals from a particular base station may comprise one or more sets of synchronization signals that serve to provide information about that particular base station, such as primary synchronization signals (PSS), secondary synchronization signals (SSS), and physical broadcast channel (PBCH) signals. The downlink signals may additionally comprise various other control and broadcast signaling in addition to physical downlink shared channel (PDSCH) signaling. As used herein, the term synchronization signals comprises any one or more messages or signaling used by a base station, such as the victim base station 210 and the target base station 220, to provide the UE 202 with information used to perform cell search and cell selection/reselection (referred to as “cell selection” herein); synchronization signals comprise the master information block (MIB) and any one or more system information block (SIBs).

A base station 204 may communicate essential information to the UEs 202 through the MIB. The MIB carries critical network information that allows UE 202 to synchronize with the base station 204 and acquire basic network parameters. The MIB is broadcasted by the base station in LTE networks periodically. The periodic term may be about every 40 ms. The UE 202 monitors the MIB broadcast to synchronize their timing with the base station and acquire the necessary information to access the network. A key piece of information communicated to UEs 202 from a base station 204 using the MIB is a reference to one or more SIBs.

The one or more SIBs contains information related to the cell selection. Cell selection is the process by which the UE 202 chooses one or more cells of a plurality of candidate cells to camp on (i.e., attach/connect to). Though the UE 202 may perform cell selection under various circumstances, the UE 202 will perform cell selection upon transitioning from an idle mode to a connected mode; for example, when the UE 202 deactivates airplane mode or makes requests to one or more base stations of the network environment 200 after a period of inactivity. The one or more SIBs comprise numerous fields, relevantly including a reselection priority value, a minimum signal strength value, and a minimum signal quality value for a particular cell.

Network environment 200 includes user equipment (UE) 202 configured to wirelessly communicate with the one or more base stations of the network environment 200. The UE 202 may take on a variety of forms, such as a personal computer (PC), a user device, a smart phone, a smart watch, an extended reality (XR) device, Internet of Things (IoT) device, a laptop computer, a mobile phone, a mobile device, a tablet computer, a wearable computer, a personal digital assistant (PDA), a server, a CD player, an MP3 player, a global positioning system (GPS) device, a video player, a handheld communications device, a workstation, a router, a hotspot, and any combination of these delineated devices, or any other device that comprising any one or more feature of computing device 100 of FIG. 1.

In order to connect to any base station, the UE 202 must perform an active search to determine which base stations, if any, it is capable of connecting to. This process is known to many in the art and referred to herein as a cell search, and generally comprises acquiring time and frequency synchronization with a cell associated with a base station and detecting an identity of that cell by tuning to one or more specific frequencies, detecting/decoding synchronization signals, detecting/decoding a physical broadcast channel (PBCH), and detecting/decoding the physical downlink shared channel (PDSCH). When performing the cell search, a particular UE typically actively scans frequency bands in which it is capable of communicating for synchronization signals from a base station. Upon detection of synchronization signals from one or more base stations, the UE will perform a cell selection procedure (typically based on best quality of service metrics or finding a cell with a network identifier that matches its own), perform an attachment procedure with the base station, and then being carrying out a wireless communication session.

The network environment 200 additionally comprises one or more hardware and/or software components that, together, make up a time of flight (TOF) mitigation engine 230. The TOF mitigation engine 230 may be said to comprise a monitor 232, an analyzer 234, and a controller 236. The monitor 232 is generally configured to determine that TOF interference is taking place and affecting the ability of the UE 202 to utilize the victim base station 210. The analyzer 234 is generally configured to determine that the UE 202 is capable of connecting to the target base station 220 as an alternative to the victim base station 210. The controller 236 is generally configured to modify and communicate one or more synchronization signals from one or more of the victim base station 210 and the target base station 220 to the UE 202 that cause the UE 202 to select and attach to the target base station 220 instead of the victim base station 210.

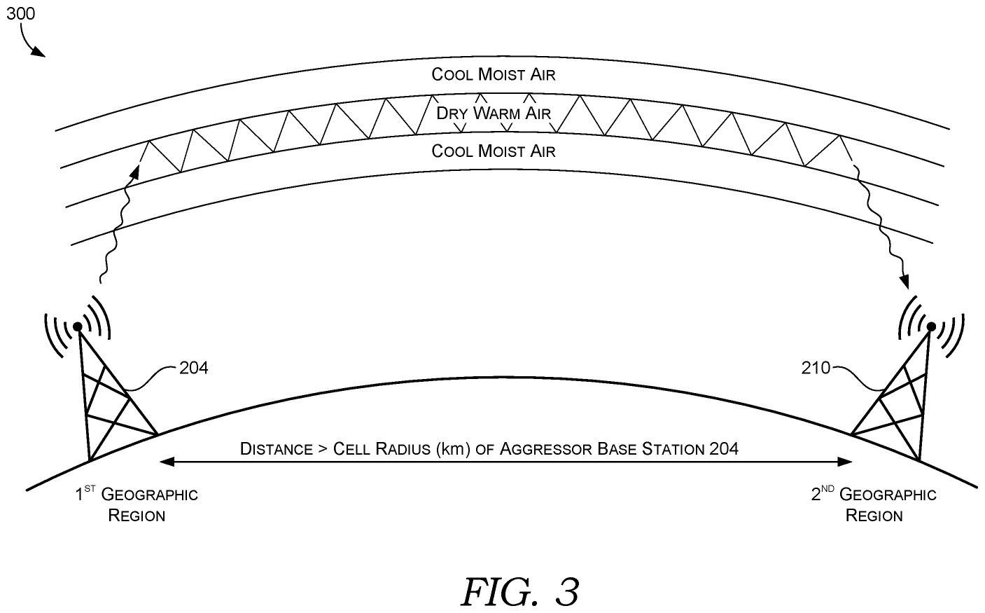

The monitor 232 is generally configured to determine that TOF interference is taking place in a first cell, in which the UE 202 is located. Any suitable means for determining the existence of TOF interference would be suitable for use with the present disclosure, including the use of tropospheric ducting forecasts, observations of the third downlink 206 comprising a cell identifier of the aggressor base station 204 (combined with a determination that the aggressor cell 204 is located greater than a predetermined threshold distance from the first cell), or by determining that a signal parameter is sufficiently different at a first portion of an uplink time period (e.g., an uplink subframe) when compared to a second, later, portion of the uplink time period. An illustration of tropospheric ducting is presented in FIG. 3. As shown, the aggressor base station 204 of FIG. 2 may be located in the first geographic region and may broadcast radio frequency signals, which become trapped in a layer or duct of dry, warm air positioned in between layers of cool, moist air. These radio frequency signals travel a greater distance than intended, beyond the cell radius of the aggressor base station 204, to the victim base station 210, located in a second geographic region. When signals from the aggressor base station 204 are of sufficiently proximate frequencies, they can cause interference at the victim base station 210, particularly when the victim base station 210 utilizes TDD and the downlink signals from the aggressor base station 204 arrive during an uplink time period of the victim base station 210. That is, as the victim base station 210 may realize noise from the downlink signals of the aggressor base station 204 when the victim base station 210 is scheduled to be receiving uplink signals from a UE.

Returning to FIG. 2, the monitor 232 may determine that TOF interference is affecting the first cell based on one or more signal parameters being sufficiently different during different portions of an uplink time period (e.g., an uplink subframe). The monitor 232 may utilize observations of the one or more signal parameters by the victim base station 210 or measurement reports from one or more UEs within a predetermined threshold distance of the victim base station 210. The one or more signal parameters may comprise a signal strength, signal quality, or noise value (e.g., signal to interference noise ratio (SINR)). The monitor 232 may utilize a first observation of the one or more signal parameters at a first point in the uplink time period. In aspects, the first point in the uplink time period may be a configurable threshold amount of time from the beginning of the uplink time period. The monitor may compare the first observation to a second observation of the one or more signal parameters at a second point in the uplink time period. In aspects, the second point in the uplink time period is subsequent to the first point and may be a configurable threshold amount of time from the end of the uplink time period. For example, if the uplink time period is 10 ms, the first point may be 1 ms after the start of the uplink time period and the second point may be 8 ms after the start of the uplink time period. If one or more values of the one or more signal parameters at the first point are within a threshold range of the one or more values of the one or more signal parameters at the second point, the monitor 232 may determine that TOF interference is not occurring (or that it cannot be mitigated). If, on the other hand, the one or more values are beyond the threshold range, the monitor 232 may determine that TOF interference is occurring and communicate such an indication to the analyzer 234. In one non-limiting example, the one or more signal parameters may be SINR and the monitor 232 may compare the SINR at 1 ms and 8 ms in to a 10 ms uplink subframe. If the predetermined threshold range is 10 dB, a SINR of 5 dB is observed in the first cell at 1 ms, and a SINR of 20 is observed in the first cell at 8 ms, then the monitor 232 may determine that TOF interference is affecting the first cell; conversely, if the SINR in the first cell is observed at 5 dB at 1 ms and 10 dB at 8 ms, then the monitor 232 may determine that TOF interference is not occurring (or it cannot be mitigated), and no further action will be taken by the TOF mitigation engine 230.

The analyzer 234 is generally configured to determine that a TOF mitigation procedure is available for the UE 202. The analyzer 234 receives an indication from the monitor 232 that TOF interference is occurring in a first cell of the victim base station 210 and determines that the victim base station 210 utilizes TDD to communicate with UEs in the first cell. In some aspects the analyzer 234 may further determine that a second cell of the target base station 220 provides coverage to at least a portion of the first cell and that the target base station uses FDD to communicate with UEs. The analyzer 234 may then communicate an indication to the controller 236 that one or more synchronization signal values of the first downlink 212 may be modified in order to prioritize the UE 202 connecting to the second cell (the target base station 220) over connecting to the first cell (the victim base station 210). In aspects where the analyzer 234 determines that the second cell of the target base station 220 provides coverage to at least a portion of the first cell, the analyzer 234 may also communicate an indication to the controller 236 that one or more synchronization signal values of the second downlink 222 may also be modified as part of the prioritization of the UE 202's selection of the second cell (the target base station 220) over the first cell (the victim base station 210).

The controller 236 is generally configured to receive indications from the analyzer 234 and instruct one or more base stations to communicate modified synchronization signals. In order to cause UEs transitioning from idle mode to connected mode to select the second cell over the first cell, the controller 236 may instruct one or more of the victim base station 210 and the target base station 220 to modify one or more values of their respective synchronization signals. In one aspect, the controller 236 may instruct the victim base station 210 to modify one or more values of the first downlink 212's synchronization signals by increasing a minimum signal strength value (e.g., q-RxLevMin), increasing a signal quality value (e.g., q-QualMin), and/or decreasing a cell selection priority value (e.g., cellReselectionPriority)—which will cause the UE 202 to prioritize other candidate cells (e.g., the second cell of the target base station 220) over cells of the victim base station 210. In another aspect, the controller 236 may instruct the target base station 220 to modify one or more values of the second downlink 222's synchronization signals by decreasing a minimum signal strength value (e.g., q-RxLevMin), decreasing a signal quality value (e.g., q-QualMin), and/or increasing a cell selection priority value (e.g., cellReselectionPriority)—which will also cause the UE 202 to prioritize the cells of the target base station 220 over cells of the victim base station 210. In yet other aspects, the controller 236 may instruct both the victim base station 210 and the target base station 220 to modify their respective synchronization signals in order to further assure prioritization of cells of the target base station 220 over cells of the victim base station 210.

Subsequent to adjusting the idle cell mode reselection priorities from TDD to FDD, the TOF mitigation engine 230 may continue to determine whether TOF interference is taking place. If TOF interference is no longer taking place, the TOF mitigation engine will roll back the changes made to the UE 202 cell selection priorities. As discussed above, the TOF mitigation engine 230 may be said to comprise a monitor 232, an analyzer 234, and a controller 236. The monitor 232 is generally configured to determine that TOF interference is no longer taking place in the cell in which the UE 202 is located and is no longer a threat to the ability of the UE 202 to utilize the victim base station 210. The analyzer is generally configured to determine that the UE 202 is capable of connecting back to the victim base station 210. The controller 263 is generally configured to modify and communicate one of more synchronization signals from one or more of the victim base station 210 and the target base station 220 to the UE 202 that cause the UE to select and attach to the victim base station 210 instead of the target base station 220.

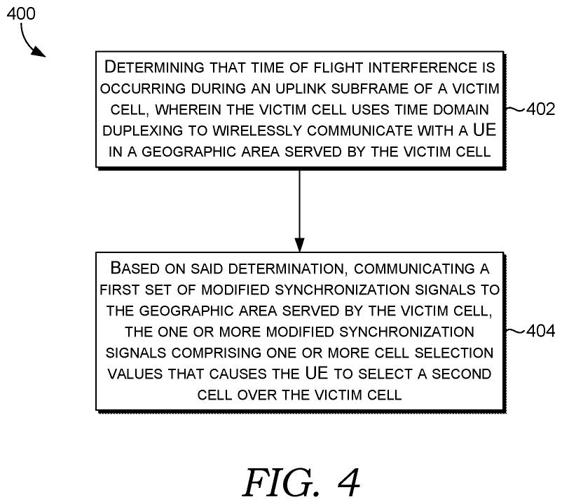

FIG. 4 depicts a flow diagram of an exemplary method for mitigating tropospheric ducting by adjusting the idle mode cell re-selection priority of a UE 202 in accordance with aspects herein. The method 400 begins with step 402 determining that time of flight interference is occurring during an uplink subframe of a victim cell, wherein the victim cell uses time domain duplexing to wirelessly communicate with a UE in a geographic area served by the victim cell. The method continues with step 404, based on said determination, communicating a first set of modified synchronization signals to the geographic area served by the victim cell, the one or more modified synchronization signals comprising one or more cell selection values that causes the UE to select a second cell over the victim cell.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents

1. A method for mitigating interference caused by a meteorological condition known as tropospheric ducting in a wireless telecommunication network, the method comprising:
determining that time of flight interference is occurring during an uplink subframe of a victim cell, wherein the victim cell uses time domain duplexing to wirelessly communicate with a UE in a geographic area served by the victim cell; and,
based on said determination, communicating a first set of modified synchronization signals to the geographic area served by the victim cell, the modified synchronization signals comprising one or more cell selection values that causes the UE to select a second cell over the victim cell.

2. The method of claim 1, wherein the second cell is configured to wirelessly communicate with the UE in at least a portion of the geographic area served by the victim cell.

3. The method of claim 2, wherein the second cell is configured to wirelessly communicate with the UE using frequency domain duplexing.

4. The method of claim 3, wherein causing the UE to select the second cell over the victim cell comprises the UE transitioning from an idle mode to a connected mode.

5. The method of claim 4, wherein the first set of modified synchronization signals comprises a system information block message.

6. The method of claim 5, wherein the method further comprises communicating, by the second cell, a second set of modified synchronization signals comprising a second cell selection value, and wherein the combination of the one or more cell selection values and the second cell selection value cause the UE to select the second cell over the victim cell.

7. The method of claim 6, wherein determining that time of flight interference comprises determining one or more parameters of an air interface during each of a first portion of the uplink subframe and a second portion of the uplink subframe.

8. The method of claim 7, wherein the first portion of the uplink subframe is within a first configurable threshold time of the beginning of the uplink subframe and the second portion of the uplink subframe is within a second configurable threshold time of the end of the uplink subframe.

9. The method of claim 8, wherein the one or more parameters of the air interface comprises a signal strength.

10. The method of claim 8, wherein the one or parameters of the air interface comprises a signal to noise interference noise ratio (SINR).

11. The method of claim 10, wherein the one or more cell selection values comprises a cell reselection priority field.

12. The method of claim 10, wherein the one or more cell selection values comprises a minimum receive power level.

13. A system for mitigating interference caused by a meteorological condition known as tropospheric ducting in a wireless telecommunication network, the system comprising:
one or more computer processing components configured to perform operations comprising:
determining that time of flight interference is occurring during an uplink subframe of a victim cell, wherein the victim cell uses time domain duplexing to wirelessly communicate with a UE in a geographic area served by the victim cell; and,
based on said determination, communicating a first set of modified synchronization signals to the geographic area served by the victim cell, the modified synchronization signals comprising one or more cell selection values that causes the UE to select a second cell over the victim cell.

14. The system of claim 13, wherein causing the UE to select the second cell over the victim cell comprises the UE transitioning from an idle mode to a connected mode.

15. The system of claim 14, wherein the first set of modified synchronization signals comprises a system information block message.

16. The system of claim 13, wherein determining that time of flight interference comprises determining one or more parameters of an air interface during each of a first portion of the uplink subframe and a second portion of the uplink subframe.

17. A non-transitory computer readable media having instructions stored thereon that, when executed by one or more computer processing components, cause the one or more computer processing components to perform a method for mitigating interference caused by a meteorological condition known as tropospheric ducting in a wireless telecommunication network, the method comprising:
determining that time of flight interference is occurring during an uplink subframe of a victim cell, wherein the victim cell uses time domain duplexing to wirelessly communicate with a UE in a geographic area served by the victim cell; and,
based on said determination, communicating a first set of modified synchronization signals to the geographic area served by the victim cell, the modified synchronization signals comprising one or more cell selection values that causes the UE to select a second cell over the victim cell.

18. The method of claim 17, wherein the second cell is configured to wirelessly communicate with the UE in at least a portion of the geographic area served by the victim cell.

19. The method of claim 18, wherein the second cell is configured to wirelessly communicate with the UE using frequency domain duplexing.

20. The method of claim 19, wherein causing the UE to select the second cell over the victim cell comprises the UE transitioning from an idle mode to a connected mode.
